(19) United States
(12) Patent Application Publication
(10) Pub. No.: US 2006/0098317 A1
(43) Pub. Date: May 11, 2006

(54) Method of disk delivery of magnetic transfer apparatus, disk holding apparatus and magnetic transfer method and apparatus using same

(75) Inventor: Akihisa Kita, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/267,408

(22) Filed: Nov. 7, 2005

(30) Foreign Application Priority Data
Nov. 8, 2004 (JP) 2004-324099
Nov. 8, 2004 (JP) 2004-324101

(51) Int. Cl. G11B 5/86; G11B 5/012

(52) U.S. Cl. 360/17; 360/97.01

(57) ABSTRACT

The present invention provides a magnetic transfer apparatus comprising: a disk holding apparatus including a chuck which has one or more suction openings at its end and absorbs a disk with the suction openings, wherein a channel in communication with the suction openings is provided in the chuck, and a depressurization piping system route and a pressurization piping system route connected to the channel are switchable; a supply device which carries a slave disk absorbed by an absorption chuck of the disk holding apparatus and supplies it to be opposed to the master disk held by the holder portion; and a magnetic field application device which adds a magnetic field to the holder portion to transfer the magnetic pattern of the master disk to the slave disk.

### BACKGROUND OF THE INVENTION

1. Field of the Invention

The present invention relates to a method of disk delivery of a magnetic transfer apparatus, a disk holding apparatus and magnetic transfer method and apparatus using the same, and in particular, to the method of disk delivery of a magnetic transfer apparatus, disk holding apparatus and magnetic transfer method and apparatus using the same which are suitably applicable when transferring a magnetic information pattern such as format information to a magnetic disk used for a hard disk drive and so on from a master disk.

2. Description of the Related Art

As for a magnetic disk (hard disk) used for a hard disk drive rapidly widespread in recent years, format information and address information are generally written to it before being built into the drive after it is delivered to a drive manufacturer from a magnetic disk manufacturer. This writing can be performed by a magnetic head. However, it is efficient and desirable to use a magnetic transfer apparatus for collectively transferring it to a subject disk for transfer (slave disk) from a master disk having the format information and address information written thereto.

Conventionally, various proposals have been made as this kind of magnetic transfer technique (refer to Japanese Patent Application Laid-Open No. 2001-250227, Japanese Patent Application Laid-Open No. 2002-15421 and Japanese Patent Application Laid-Open No. 2001-351234, for instance). Japanese Patent Application Laid-Open No. 2001-250227 thereof is a proposal to improve working efficiency on performing a magnetic transfer by intermittently driving one handler.

Japanese Patent Application Laid-Open No. 2002-15421 is a proposal to set surface hardness of points of contact of a vacuum contact chuck to a predetermined value or more on handling the slave disk, thereby improve wear of the vacuum contact chuck and improve parallelism of the master disk and slave disk. Japanese Patent Application Laid-Open No. 2001-351234 is a proposal to improve a degree of cleanness on performing the magnetic transfer and thereby extend life of the master disk.

As for the magnetic transfer apparatus, there is a widely adopted method of delivering the slave disk absorbed and carried by a supply device including an absorption chuck to the absorption chuck of a holder portion, attaching the slave disk firmly to the master disk and adding a magnetic field to the holder portion in this state so as to transfer a magnetic pattern of the master disk to the slave disk. When attaching the slave disk firmly to the master disk, it is necessary to render mutual disk centers matching. Therefore, there is a problem that the magnetic pattern of the master disk is not correctly transferred to the slave disk if the slave disk is deformed or displaced (disk centers do not match) on having the slave disk delivered from the absorption chuck of the supply device to the absorption chuck of the holder portion.

As for a countermeasure against it, Japanese Patent Application Laid-Open No. 2001-325725 for instance discloses the magnetic transfer apparatus wherein, when the master disk and slave disk are put in face-to-face contact by holding them on a disk holder by vacuum suction, a central part of the master disk is not deformed to the slave disk side on attaching the slave disk firmly to the master disk by performing the vacuum suction from a suction opening for firm attachment of an absorption holding portion for absorbing and holding the slave disk and also performing the vacuum suction from a suction opening for preventing deformation formed in the central part of the disk holder.

### SUMMARY OF THE INVENTION

As for such conventional techniques, however, there is an indicated problem that the master disk has short life and must be frequently replaced. To be more specific, while it is necessary to attach the master disk firmly to the hard disk to be transferred to (slave disk), there are many cases where scratches are generated on a surface of the master disk by fine particles and dirt if cleanliness in this environment is inferior. The slave disk to be magnetically transferred to also has its transfer yield lowered by the fine particles and dirt.

For this reason, a conventional magnetic transfer apparatus is mostly installed in a clean booth of which cleanliness is good. There is also a proposal for a contraption for avoiding retention of clean air as in Japanese Patent Application Laid-Open No. 2001-351234.

Even if the apparatus is installed in the clean booth of which cleanliness is good and a magnetic transfer is performed therein, however, it is pointed out that dust is generated from the vacuum contact chuck to contaminate surroundings in the case of using the vacuum contact chuck on handling the slave disk as disclosed in Japanese Patent Application Laid-Open No. 2002-15421. This phenomenon will be described hereunder.

FIG. 9 is a sectional view for describing a general positional relation between a vacuum contact chuck 1 and a slave disk 2. The slave disk 2 is an annular (doughnut-shaped) disk. The vacuum contact chuck 1 is a disc-like member, where an annular portion 1A at its end contacts the surface of the slave disk 2 and a suction pipe 1B is erected on its backside. An air filter 3 is placed in the middle of the suction pipe 1B.

The vacuum contact chuck 1 introduces the air via the suction pipe 1B by a depressurization device (vacuum pump or the like) not shown in a direction of a solid arrow 4 of FIG. 9 to absorb and hold the slave disk 2, carry the absorbed and held slave disk 2 to a position opposed to the master disk (omitted in the drawing) and provide it so as to be firmly attached to the master disk.

Next, the slave disk 2 is firmly attached to and held by the master disk by use of a fixing device provided on the periphery of the master disk. Thereafter, the vacuum contact chuck 1 releases the absorbed and held state of the slave disk 2. In this case, the absorbed and held state of the slave disk 2 is released by air-pressurizing it with an unshown pressurization device (or open air) in the direction of a dashed arrow 5 of FIG. 9 by way of the suction pipe 1B.

If the fine particles and dirt exist in the air on air-pressurizing, the slave disk and its periphery become contaminated. Even if the air filter 3 is placed in the middle of the suction pipe 1B as shown in FIG. 9, the fine particles and dirt in the air held by the air filter 3 on air suction (direction of a solid arrow 4) are blown back on air pressurization (direction of a dashed arrow 5) so as to provide no solution.

In such cases, the fine particles and dirt adhere to the surface of the slave disk, which generates the scratches on the surface of the master disk and lowers the transfer yield of the slave disk.

The present invention has been made in view of such circumstances, and an object thereof is to provide a disk holding apparatus capable of solving the problems by securing sufficient cleanliness on the magnetic transfer, remarkably improving the life of the master disk and improving the transfer yield of the slave disk and magnetic transfer method and apparatus using the same

The magnetic transfer apparatus of Japanese Patent Application Laid-Open No. 2001-325725 can prevent deformation of the slave disk when delivered to the holder portion but cannot prevent a displacement of an absorption position on delivery. This displacement is apt to occur on releasing the absorption of the absorption chuck of the supply device.

The present invention has been made in view of such circumstances, and another object thereof is to provide the method of disk delivery of the magnetic transfer apparatus and the magnetic transfer apparatus which generate no displacement on delivering the subject disk for transfer (slave disk) absorbed and carried by the supply device including the absorption chuck to the absorption chuck of the holder portion.

To attain the objects, the present invention according to a first aspect provides a disk holding apparatus having one or more suction openings at its end and comprising a chuck which absorbs a disk with the suction openings, wherein: a channel in communication with the suction openings is provided in the chuck, and a depressurization piping system route and a pressurization piping system route connected to the channel are switchable.

The present invention according to a second aspect provides a magnetic transfer method comprising the steps of: absorbing the slave disk with the absorption chuck by use of the disk holding apparatus; carrying the absorbed slave disk and supplying it to be opposed to the master disk held by the holder portion; pressure-welding the master disk to the supplied slave disk to hold the supplied slave disk tightly; and adding a magnetic field to the holder portion to transfer the magnetic pattern on the master disk to the slave disk.

The present invention according to a third aspect provides a magnetic transfer apparatus comprising: a holding device which holds a master disk having a magnetic pattern with a holder portion; and the disk holding apparatus, and further comprising: a supply device which carries a slave disk absorbed by an absorption chuck of the disk holding apparatus and supplies it to be opposed to the master disk held by the holder portion; and a magnetic field application device which adds a magnetic field to the holder portion to transfer the magnetic pattern of the master disk to the slave disk.

According to the present invention, the depressurization piping system route and the pressurization piping system route connected to the channel in the chuck for absorbing and holding the subject disk for transfer (slave disk) are switchable. Therefore, it is possible to use the depressurization piping system route on absorbing the slave disk and use the pressurization piping system route on releasing the slave disk so as to prevent the slave disk and its periphery from getting contaminated by discharging fine particles and dirt from the chuck.

To be more specific, the fine particles and dirt in the air held by an air filter 3 are not blown back on air pressurization as in the conventional example (FIG. 9), and it is possible to supply the air of high cleanliness by use of a unique pressurization piping system route and thereby release the slave disk. Therefore, it is possible to prevent the slave disk and its periphery from getting contaminated.

The present invention according to a forth aspect, it is desirable to have the pressurization piping system route opened to atmospheric pressure. Thus, it is possible to release the slave disk easily even if the pressurization piping system route is open to the atmospheric pressure without providing a unique pressurization device.

The present invention according to a fifth aspect, it is desirable to have a filter device provided in the depressurization piping system route and/or the pressurization piping system route. Thus, if the filter device is provided in the piping system route, it is possible to further improve the cleanliness of the air so as to render the present invention further effective.

To attain the objects, the present invention according to a sixth aspect provides a method of disk delivery of a magnetic transfer apparatus which magnetically transfers a magnetic pattern of a master disk held by a holder portion to a slave disk, and absorbs and carries the slave disk with a supply device including a first absorption chuck to deliver it to a second absorption chuck of the holder portion, wherein: the slave disk is absorbed by the second absorption chuck by rendering absorptive power for absorbing the slave disk with the second absorption chuck higher than the absorptive power of the first absorption chuck and absorption of the first absorption chuck is released thereafter.

According to the sixth aspect of the present invention, the slave disk is absorbed by the second absorption chuck by rendering the absorptive power for absorbing the slave disk with the second absorption chuck of the holder portion higher than the absorptive power of the first absorption chuck of the supply device and absorption of the first absorption chuck is released thereafter. Therefore, no displacement is generated on delivering the slave disk from the first absorption chuck to the second absorption chuck. In this case, the slave disk may move due to an air pressure on releasing the absorption of the first absorption chuck when the absorptive power of the first and second absorption chucks is the same or the absorptive power of the second absorption chuck is smaller.

Here, the absorptive power of the first and second absorption chucks represents the power represented by a product of absorption pressure and absorption area. Therefore, in the case of representing the relation between the first and second absorption chucks of the present invention by using the absorption pressure and absorption area, it is represented as follows. The absorption pressure of the second absorption chuck (P2) is rendered higher [P2>P1×(A1/A2)] than a value [P1×(A1/A2)] of multiplying the absorption pressure of the first absorption chuck (P1) by a ratio of the absorption area of the first absorption chuck (A1) to the absorption area of the second absorption chuck (A2) (A1/A2) so that the slave disk is absorbed by the second absorption chuck and the absorption of the first absorption chuck is released thereafter.

A seventh aspect is the invention in the sixth aspect, wherein, on delivering the slave disk from the first absorption chuck to the second absorption chuck, it is delivered in a state of having a displacement prevention guide provided to the first or second absorption chuck fitted into a center opening or a peripheral rim of the slave disk.

As above, the displacement of the slave disk is apt to occur especially on releasing the absorption of the first absorption chuck for absorbing and holding the slave disk. It is possible, however, to prevent the displacement securely because the absorption is released in the state of having the displacement prevention guide fitted into the center opening or peripheral rim of the slave disk.

To attain the objects, a eighth aspect of the present invention provides a magnetic transfer apparatus for transferring a magnetic pattern of a master disk held by a holder portion to a slave disk and absorbing and carrying the slave disk with a supply device including a first absorption chuck to deliver it to a second absorption chuck of the holder portion, the apparatus comprising: a control device which controls an absorption and release device of the first and second absorption chucks to have the slave disk absorbed by the second absorption chuck by rendering absorptive power for absorbing the slave disk with the second absorption chuck higher than the absorptive power of the first absorption chuck and release absorption of the first absorption chuck thereafter.

According to the eighth aspect of the present invention, the control device causes the slave disk to be absorbed by the second absorption chuck by rendering absorptive power for absorbing the slave disk with the second absorption chuck of the holder portion higher than the absorptive power of the first absorption chuck of the supply device and causes the absorption of the first absorption chuck to be released thereafter. Therefore, no displacement is generated on delivering the slave disk to the second absorption chuck of the holder portion.

A ninth aspect is the invention according to the eighth aspect, comprising a displacement prevention guide which is provided to at least one of the first and second absorption chucks and prevents a displacement of an absorption position on delivery from the first absorption chuck to the second absorption chuck.

According to the ninth aspect of the invention, the slave disk is delivered to the second absorption chuck of the holder portion in the state of having the displacement prevention guide provided to the first or second absorption chuck fitted into the center opening or peripheral rim of the slave disk in addition to control over the first and second absorption chucks with the control device described in the eighth aspect. It is thereby possible to prevent the displacement of the slave disk more securely.

A tenth aspect is the invention according to the ninth aspect, wherein an end of the displacement prevention guide is formed so as not to project from an opposite surface of an absorption surface of the slave disk.

According to the tenth aspect of the invention, the end of the displacement prevention guide is formed so as not to project from the opposite surface of the absorption surface of the slave disk, and so the end of the displacement prevention guide does not contact and interfere with the holder portion on delivering the slave disk from the first absorption chuck of the supply device to the second absorption chuck of the holder portion.

A eleventh aspect is the invention according to the ninth aspect or the tenth aspect of the invention, wherein the displacement prevention guide is formed to be fitted into a center opening formed on the slave disk.

According to the eleventh aspect, the displacement prevention guide is fitted into the center opening formed on the slave disk on delivering the slave disk from the first absorption chuck to the second absorption chuck. Owing to the displacement prevention guide, the delivery is performed in the state of having the absorption chucks and the slave disk correctly positioned. Therefore, it is possible to prevent the displacement of the absorption position on the delivery.

A twelfth aspect is the invention according to the ninth aspect or the tenth aspect, wherein the displacement prevention guide is formed to be fitted into a peripheral rim of the slave disk.

According to the twelfth aspect, the displacement prevention guide is fitted into the peripheral rim of the slave disk on delivering the slave disk from the first absorption chuck to the second absorption chuck. Owing to the displacement prevention guide, the delivery is performed in the state of having the absorption chucks and the slave disk correctly positioned. Therefore, it is possible to prevent the displacement of the absorption position on the delivery.

As described above, according to the present invention, the depressurization piping system route and the pressurization piping system route connected to the channel in the chuck for absorbing and holding the subject disk for transfer (slave disk) are switchable. Therefore, it is possible to use the depressurization piping system route on absorbing the slave disk and use the pressurization piping system route on releasing the slave disk so as to prevent the slave disk and its periphery from getting contaminated by discharging fine particles and dirt from the chucks.

According to the present invention, no displacement is generated on delivering the slave disk absorbed and carried by the supply device including the absorption chuck to the absorption chuck of the holder portion.

### BRIEF DESCRIPTION OF THE DRAWINGS

FIG. 1 is a perspective view showing a ruptured part of a magnetic transfer apparatus according to the present invention;

FIG. 2 is a perspective view showing a state of putting a slave disk in and out of a cassette for a disk;

FIG. 3 is a sectional view showing a configuration of a holder unit;

FIGS. 4A and 4B are sectional views describing a chuck mechanism;

FIG. 5 is a perspective view showing a positioning state of a master disk and a slave disk;

FIGS. 6A and 6B are sectional views describing another form of the chuck mechanism;

FIGS. 7A and 7B are schematic diagrams for describing another embodiment of a displacement prevention guide provided to the chuck mechanism;

FIG. 8 is a schematic diagram for describing a mechanism which delivers the slave disk absorbed by an absorption chuck of a disk supply unit to a fixed side holder holding the master disk; and

FIG. 9 is a sectional view describing a general positional relation between a vacuum contact chuck and the slave disk.

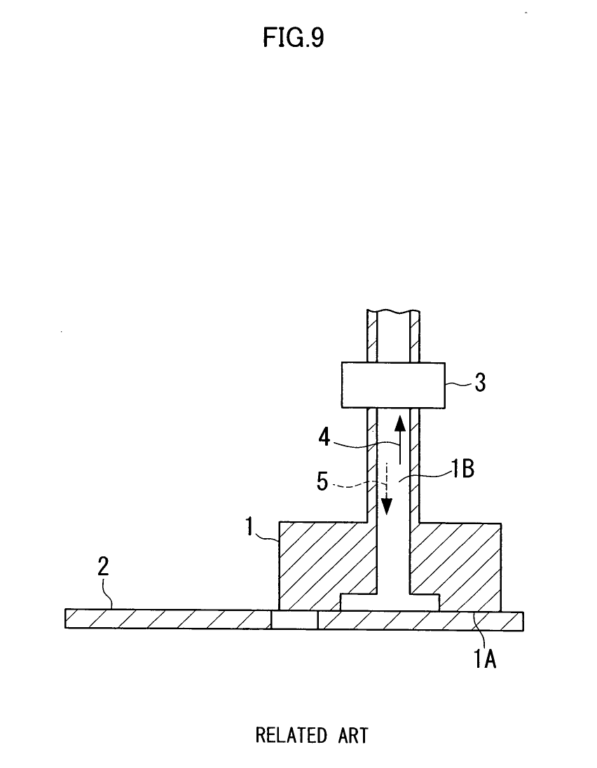

### DETAILED DESCRIPTION OF THE PREFERRED EMBODIMENTS

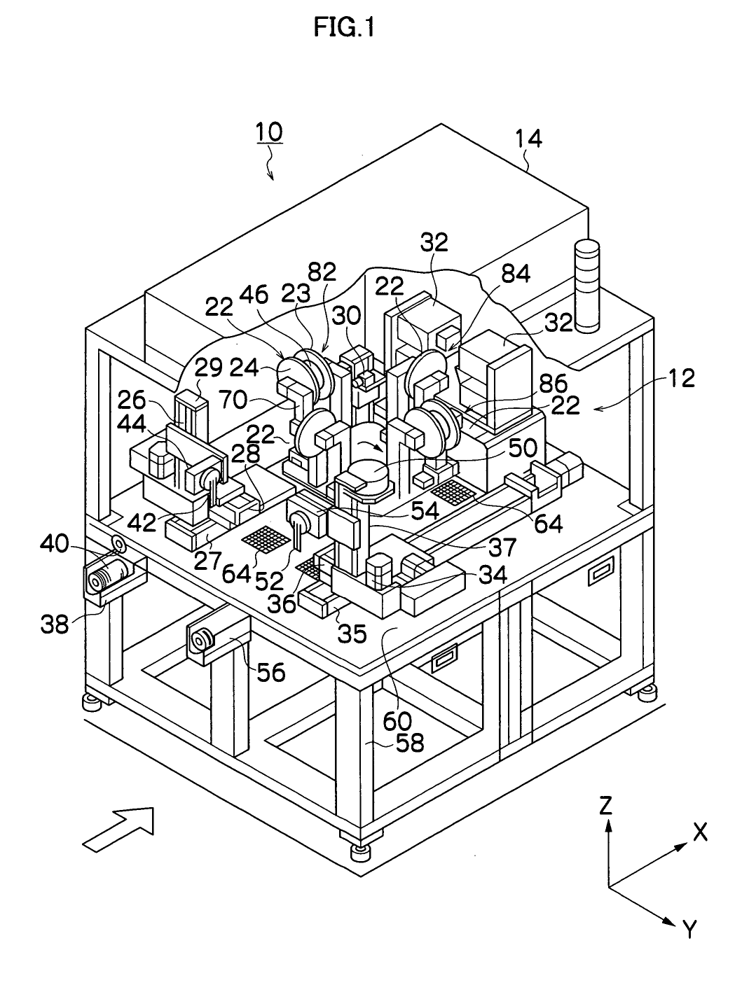

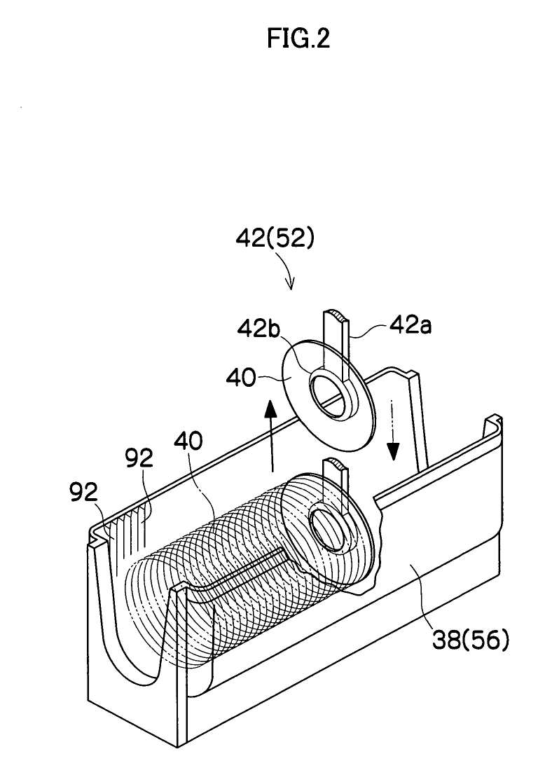

Hereunder, preferred embodiments related to the present invention will be described according to the attached drawings. FIG. 1 is a perspective view showing an overall configuration of a magnetic transfer apparatus 10 according to the present invention, and FIG. 2 is a perspective view showing an overview of a cassette for a disk. The magnetic transfer apparatus 10 includes an apparatus proper 12 and a clean unit 14 entirely covering the apparatus proper 12.

The apparatus proper 12 has a mount 58 on which a base 60 forming a surface horizontally is provided. The side indicated by a broad arrow is a front of the apparatus proper 12. The apparatus proper 12 has its surroundings enclosed by the clean unit 14 to secure cleanliness.

The clean unit 14 has a clean air blasting unit (not shown) for supplying clean air inside the apparatus provided in its ceiling portion. The clean air blasting unit is configured by an air filter such as a HEPA filter or a ULPA filter and a blasting fan, and is capable of supplying clean air below a cleanliness class 100 due to down flow inside the apparatus.

The clean air blown out by the clean air blasting unit is discharged outside. For this reason, as shown in FIG. 1, multiple exhaust fans 64 as exhaust devices are mounted in a space area on the base 60 in which mechanisms of the apparatus proper 12 are not placed.

At an anterior end of the base 60, there are a disk supply cassette 38 for housing a slave disk 40 as a slave disk and a disk ejection cassette 56 as a cassette for recovering the slave disk 40 having magnetic information transferred thereto and ejected. The disk supply cassette 38 and disk ejection cassette 56 are in the same form.

As shown in FIG. 2, the disk supply cassette 38 and disk ejection cassette 56 are capable of housing multiple slave disks 40 by having their surfaces mutually opposed. To be more specific, the slave disks 40 are loosely inserted piece by piece into each of multiple grooves 92, 92 formed in parallel with an inner surface of the cassette. The peripheries of the slave disks 40 are held by the surface made by the grooves 92, and the multiple slave disks 40 are mutually placed apart.

In FIG. 1, an index table 50 is rotatably mounted on the base 60 by a vertical axis to the base 60 approximately at the center of a top surface of the base 60. The index table 50 has four holder units 22 placed at even intervals (every 90 degrees) in a rotation direction of the index table 50, each holder unit 22 as a holding device holding a pair of master disks 46 and one slave disk 40.

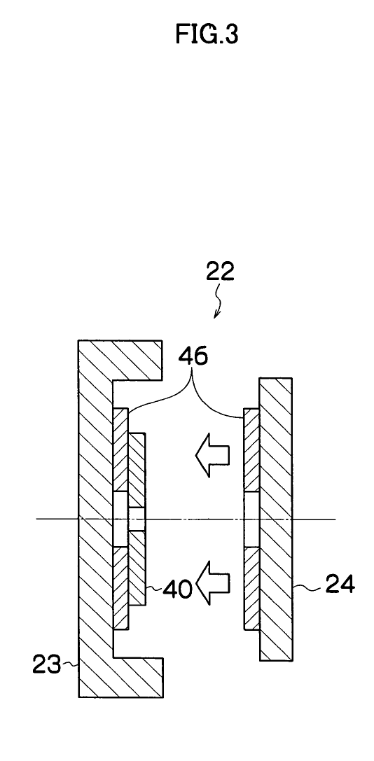

As shown in the sectional view of FIG. 3, the holder unit 22 includes a fixed side holder 23 and a moving side holder 24 as a pair of holder portions. The fixed side holder 23 and moving side holder 24 can position, fix and hold the master disks 46 by absorption or adhesion and off-line setup, and also absorbs and holds the slave disk 40 so as to have the slave disk 40 held tightly by the master disks 46, 46 in a firmly attached state.

The fixed side holder 23 and moving side holder 24 fix the master disks 46, 46 having different information recorded thereon on each of the fixed side holder 23 and moving side holder 24 in order to correspond to the magnetic information to be recorded on the respective principal surfaces of the slave disks 40. And it is possible to attach the pair of master disks 46, 46 firmly to the respective principal surfaces of the slave disks 40 so as to have them sandwiched.

The fixed side holder 23 is a circular cup-shaped member in which the master disks 46 can be fixed via an unshown cushion member. The moving side holder 24 is a disc-like member capable of fixing the master disks 46 on its surface via the unshown cushion member.

Unshown axis members are erected at the centers of backsides (opposite surfaces of the surfaces on which the master disks 46 are fixed) of the fixed side holder 23 and moving side holder 24 respectively. One of the axis members is fixed on the apparatus proper 12. Another axis member is fixed on the apparatus proper 12 via a driving device (not shown) to be detachably movable to the fixed side holder 23.

According to the configuration of the holder unit 22 described above, when supplying or removing the slave disks 40, the fixed side holder 23 and moving side holder 24 are set at positions apart by a predetermined distance so as to facilitate handling of the slave disks 40 by a disk supply unit 26 and a disk ejection unit 34 described later.

When transferring the slave disks 40 or forming enclosed space inside the holder unit 22, the fixed side holder 23 and moving side holder 24 are put in contact and the enclosed space is formed inside the holder unit 22. It is thereby possible to secure sufficient cleanliness inside the holder unit 22 and improve life of the master disks 46 dramatically. Inside the holder unit 22, a predetermined clearance is formed between the master disks 46, 46 so as to avoid mutual contact between the master disks 46, 46. The holder unit 22 also has a gap formed therein when the slave disks 40 is supplied to the holder unit 22.

On the apparatus proper 12 of FIG. 1, the index table 50 is driven to rotate intermittently by an unshown drive motor and is sent to each process position sequentially and stopped so that each holder unit 22 corresponds to each indexing position to allow multiple operations to be performed in parallel. The index table 50 is driven intermittently so as to have the four holder units 22 constantly placed at four predetermined positions. To be more specific, each holder unit 22 stops at each move of 90 degrees.

Furthermore, the apparatus proper 12 of FIG. 1 has the disk supply unit 26 on one side (left side from the front in FIG. 1) of the top surface of the base 60 and the disk ejection unit 34 on the other side (right side from the front in FIG. 1) of the top surface of the base 60 respectively.

The disk supply unit 26 is a disk supply device capable of directly carrying the slave disks 40 from the disk supply cassette 38 to the holder unit 22 having the master disks 46, 46 mounted thereon without delivering the slave disks 40 to another chuck mechanism on the way.

Inversely, the disk ejection unit 34 is a disk ejection device capable of directly carrying the slave disks 40 having completed magnetic transfer work to the disk ejection cassette 56 without delivering them to another chuck mechanism on the way.

The slave disk 40 taken out of the disk supply cassette 38 by the disk supply unit 26 is relatively positioned against the master disk 46 mounted in advance on the fixed side holder 23 of the holder unit 22. The slave disk 40 is then absorbed and delivered by the holder unit 22 over the gap provided to the master disk 46 to be held by firmly attaching a magnetic information recording surface of the master disk 46 to a magnetic information transferred surface of the slave disk 40. An absorption groove (not shown) for absorbing proximity of an internal diameter of the slave disk 40 is provided inside the fixed side holder 23 so that the slave disk 40 is absorbed and held by this absorption groove.

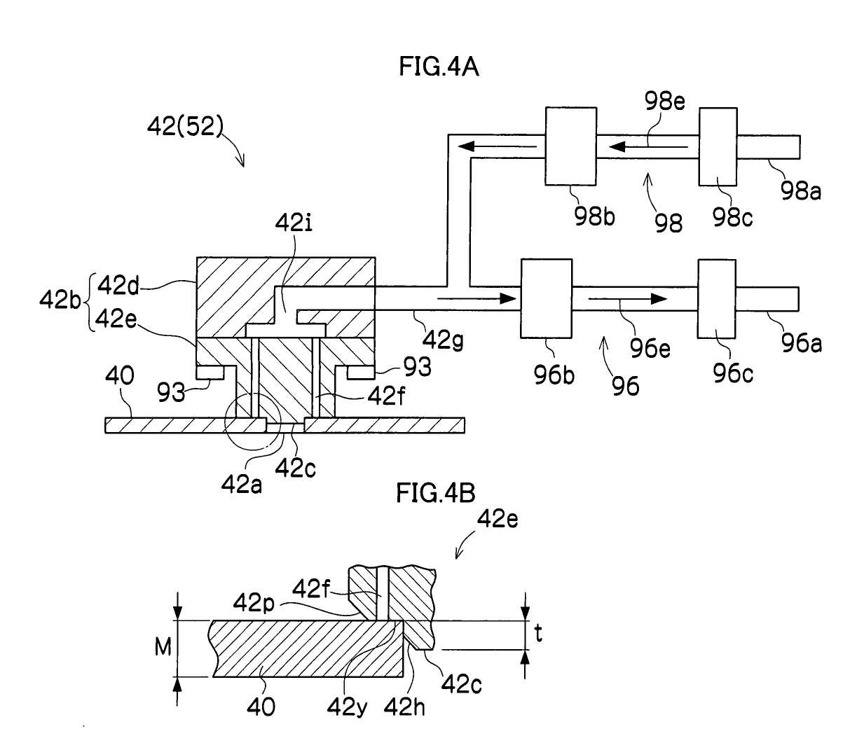

The disk supply unit 26 is mainly configured by a chuck mechanism 42 for grasping the slave disk 40 as shown in FIGS. 2, 4A, and 4B, robots 27, 28 and 29 of X, Y and Z axes as shown in FIG. 1 and a rotary cylinder 44 having a rotary axis in a Y-axis direction for rotating the chuck mechanism 42 to rotate the slave disk 40 by 180 degrees within a X to Z plane as shown in FIG. 1.

The chuck mechanism 42 is provided on a chuck arm 42a having one end (base) thereof supported by the rotary cylinder 44 and the other end (leading edge) of the chuck arm 42a, and is configured by an absorption chuck 42b for absorbing an inner periphery portion of the slave disk 40 and a displacement prevention guide 42c for preventing a displacement of an absorption position on and after absorbing the slave disk 40 with the absorption chuck 42b.

To be more specific, the disk supply unit 26 rotates the chuck mechanism 42 having absorbed the inner periphery portion of the slave disk 40 by 180 degrees with the rotary cylinder 44 so as to invert the direction of the slave disk 40 and chuck mechanism 42.

FIGS. 4A and 4B are diagrams for describing the chuck mechanism 42, where A is a side sectional view and B is a partially enlarged view of inside of a circle of A describing the displacement prevention guide 42c. In FIGS. 4A and 4B, the chuck arm 42a (refer to FIG. 2) is not shown, and only a ventilation route 42g formed inside the chuck arm 42a is conceptually shown.

As shown in FIGS. 4A and 4B, the absorption chuck 42b has a main body portion 42d including a decompression chamber 42i therein and an absorption board 42e coupled by screws 93, 93. The absorption board 42e has the displacement prevention guide 42c provided thereon. To be more specific, the absorption board 42e has a projected fitting portion fitted into a center opening 40a of the slave disk 40 formed on an absorption surface 42y thereof, where the displacement prevention guide 42c is configured by the fitting portion.

In this case, the displacement prevention guide 42c may be formed either integrally with or separately from the absorption board 42e. A ring-shaped absorption opening 42f is formed outside the displacement prevention guide 42c on the absorption surface. The absorption opening 42f is in communication up to the decompression chamber 42i of the main body portion 42d. The absorption opening 42f does not need to be one continuous opening like a ring. It is also possible to form a ring shape discontinuously with multiple openings.

The main body portion 42d is connected to a depressurization piping system route 96 and a pressurization piping system route 98 for performing depressurization and releasing the depressurization via the ventilation route 42g which is a channel inside the chuck arm 42a. Thus, the absorption chuck 42b can perform or release the absorption of the inner periphery portion of the slave disk 40.

To be more specific, the ventilation route 42g in the chuck arm 42a is branched into a piping 96a of the depressurization piping system route 96 and a piping 98a of the pressurization piping system route 98. The piping 96a of the depressurization piping system route 96 has an air filter 96b as the filter device and an electromagnetic valve 96c provided thereto in order from a branching point. The end of the piping 96a is connected to a depressurization device (rotary vacuum pump for instance) not shown.

The piping 98a of the pressurization piping system route 98 has an air filter 98b as the filter device and an electromagnetic valve 98c provided thereto in order from the branching point. The end of the piping 98a is connected to a pressurization device (air pump or blower for instance) not shown.

The electromagnetic valve 96c of the depressurization piping system route 96 and the electromagnetic valve 98c of the pressurization piping system route 98 can be driven by an unshown control device (personal computer for instance) respectively. Thus, the absorption chuck 42b can perform or release the absorption of the inner periphery portion of the slave disk 40.

As shown in FIG. 4B, a taper 42h is formed in a lower portion of a peripheral surface of the displacement prevention guide 42c. The taper 42h renders the lower portion of the peripheral surface of the displacement prevention guide 42c tapered. Therefore, when absorbing the slave disk 40 with the absorption chuck 42a, the displacement prevention guide 42c is smoothly led to the center opening of the slave disk 40 so as to put the displacement prevention guide 42c and slave disk 40 in a fitted state.

It is desirable that a depth t by which the displacement prevention guide 42c is fitted into the slave disk 40 is formed to be smaller than a board thickness M of the slave disk 40. It is possible, by thus forming the depth t, to prevent contact between the end of the displacement prevention guide 42c and the master disk 46.

In FIG. 4A, the displacement prevention guide 42c is formed as a cylindrical fitted portion projecting from the absorption surface 42y. However, it is not limited to being cylindrical but may be in any form wherein multiple locations of the displacement prevention guide 42c contact an inner peripheral border of the center opening of the slave disk 40 so as to fit the displacement prevention guide 42c into the center opening.

Furthermore, it may also be, but not shown, a cylindrical shape vertically divided into multiple divided pieces. It is possible, by thus dividing it into the divided pieces, to facilitate elastic deformation of the displacement prevention guide 42c so that it becomes even easier to fit the displacement prevention guide 42c into the center opening 40a of the slave disk 40. If there are too many divided pieces, however, a fitting force becomes weaker and may be a cause of a displacement. Therefore, there should be five or fewer divided pieces.

As shown in FIG. 4B, however, it is desirable to render a thickness t of the fitted portion of the displacement prevention guide 42c smaller than the thickness M of the slave disk 40 so as not to have the end of the displacement prevention guide 42c projected from the opposite surface of the absorption surface of the slave disk 40 on absorbing the slave disk 40 with the absorption chuck 42b. This is because, if the end of the displacement prevention guide 42c is projected from the opposite surface of the absorption surface of the slave disk 40, the displacement prevention guide 42c contacts and mutually interferes with the fixed side holder 23 on placing the slave disk 40 opposite the master disk 46 and delivering the slave disk 40 to the fixed side holder 23.

As shown in FIG. 4B, it is desirable to form a taper 42p on a peripheral border of the end of the absorption board 42e. This is because, as the slave disk 40 has a servo area for having servo information on the master disk 46 transferred to in an intermediate peripheral portion of the slave disk 40 (the portion excluding the inner peripheral portion and peripheral portion of the slave disk 40), it is possible, by forming the taper 42p, to enlarge a ring diameter of the absorption opening 42f for the sake of preventing the absorption surface 42y from contacting the servo area so as to allow stable absorption.

Next, the disk ejection unit 34 will be described. The disk ejection unit 34 is a disk ejection device which receives a magnetically transferred slave disk 40, after the holder unit 22 is opened, to directly carry and house the slave disk 40 into the disk ejection cassette 56.

The disk ejection unit 34 is configured by a chuck mechanism 52 for absorbing and fixing an internal diameter portion of the slave disk 40, robots 35, 36 and 37 of the X, Y and Z axes and a rotary cylinder 54 having a rotary axis in an X-axis direction for rotating the chuck mechanism 52 to rotate the slave disk 40 by 180 degrees within a Y to Z plane.

To be more specific, the disk ejection unit 34 rotates the chuck mechanism 52 having absorbed the inner periphery portion of the slave disk 40 by 180 degrees with the rotary cylinder 54 so as to invert the direction of the slave disk 40 and chuck mechanism 52.

Of the disk ejection unit 34, the chuck mechanism 52 for grasping the slave disk 40 can have the same configuration as the chuck mechanism 42 shown in FIGS. 4A and 4B already described. Therefore, overlapping descriptions will be omitted.

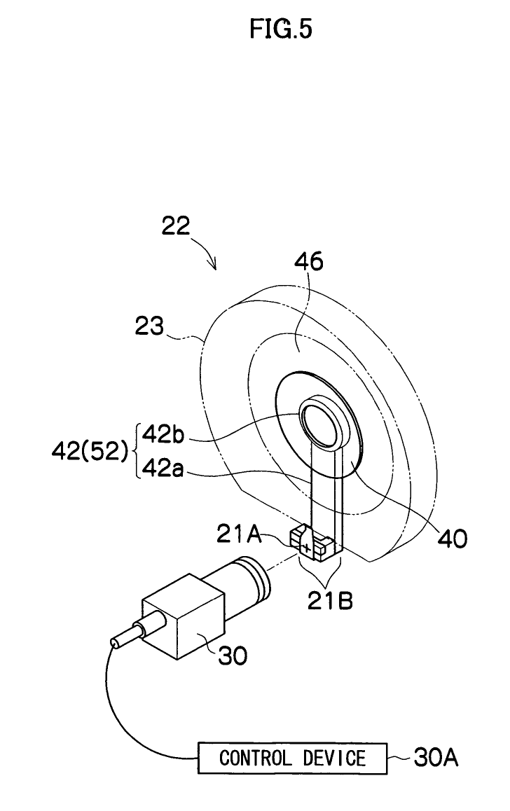

As shown in FIG. 5, a reference mark 21A is attached in advance to a lower surface of the fixed side holder 23 of the holder unit 22, and recognition marks 21B, 21B are attached in advance to the chuck mechanism 42 of the disk supply unit 26. The reference mark 21A and recognition marks 21B, 21B are visually recognized by a recognition unit 30.

The recognition unit 30 is placed at a position close to the opposite side of the side on which the disk supply cassette 38 is placed on the top surface of the base 60. When positioning the slave disk 40 carried by the disk supply unit 26 on the master disk 46, the recognition unit 30 visually recognizes the reference mark 21A and recognition marks 21B, 21B attached in advance to the holder unit 22 and disk supply unit 26 with a CCD camera or the like respectively.

The recognition unit 30 has a control device 30A as a positioning device connected thereto. The control device 30A calculates the center of the master disk 46 from the recognized reference mark 21A, and also calculates the center of the slave disk 40 from the recognized recognition marks 21B, 21B. And the control device 30A further controls the drive of the robots 28 and 29 of Y to Z axes of the disk supply unit 26 so that the center of the master disk 46 matches with the center of the slave disk 40.

The positioned slave disk 40 is moved to a position to be firmly attached to the master disk 46 held inside the fixed side holder 23 by the X-axis robot 27 of the disk supply unit 26 so as to be absorbed and held inside the fixed side holder 23.

In this case, a positional relation between the reference mark 21A provided on the fixed side holder 23 and a central location of the master disk 46 held in the fixed side holder 23 is taught to the control device 30A in advance.

As for the relation between the recognition marks 21B, 21B provided to the disk supply unit 26 and the center location of the slave disk 40, the relation between the center location and the recognition marks 21B, 21B is taught to the control device 30A in advance, considering that the center of the slave disk 40 is at the center of the displacement prevention guide 42c of the chuck mechanism 42.

The positional relation between the slave disk 40 and the master disk 46 is indirectly calculated based on the taught positional relation.

Coil units 32, 32 are the coils placed apart, by closing the holder unit 22, on both sides from a lamination direction of the master disks 46, 46 and slave disk 40 to the slave disk 40 in the state of being held tightly by the master disks 46, 46 fixed on the fixed side holder 23 and moving side holder 24 of the holder unit 22 respectively. The coil units 32, 32 apply a magnetic field of a predetermined intensity for promoting magnetic transfer action to the master disks 46, 46 and slave disk 40.

Next, a description will be given as to a method of operation of the magnetic transfer apparatus configured as above. On starting the operation, the chuck mechanism 42 of the disk supply unit 26 (absorption chuck 42b) absorbs and grasps the slave disk 40 in the disk supply cassette 38 so as to take it out one by one.

In this case, the electromagnetic valve 96c of the depressurization piping system route 96 shown in FIGS. 4A and 4B is driven to connect the ventilation route 42g of the chuck mechanism 42 (inside of the chuck arm 42a) to the depressurization device by way of the piping 96a. Thus, the air is sucked in the direction of an arrow 96e to allow the slave disk 40 to be absorbed and grasped.

The electromagnetic valve 98c of the pressurization piping system route 98 is not driven so that there is no flow of the air in the piping 98a (arrow 98e).

According to the configuration, the chuck mechanism 42 (absorption chuck 42b) does not contact a servo area 40b of the slave disk 40 on absorbing and grasping the slave disk 40, and so servo area 40b of the slave disk 40 is not damaged.

Next, the slave disk 40 taken out is inverted in the Y to Z plane by the rotation of the rotary cylinder 44, and is then moved by the X-axis robot 27 above in the direction orthogonal to an opening and closing direction of the holder unit 22 in the gap between the master disks 46, 46 formed by the opened holder unit 22 placed at a disk supply process position 82 so as to be inserted into the gap between the master disks 46, 46 by the Y-axis robot 28.

In this case, inside the fixed side holder 23 and moving side holder 24 of the holder unit 22, the master disks 46, 46 are accurately fixed in advance by the off-line setup by use of absorption or adhesion at the positions where the center of the holder unit 22 matches with the center of the master disk 46 respectively.

The slave disk 40 supplied between the fixed side holder 23 and moving side holder 24 of the holder unit 22 is moved by the robots of X to Y to Z axes of the disk supply unit 26 to a recognized position where its center approximately matches with the center of the master disk 46 fixed inside the fixed side holder 23 and the gap with the master disk 46 becomes 0.5 mm or so.

Next, the recognition unit 30 recognizes the reference mark 21A attached in advance to the lower surface of the fixed side holder 23 and the recognition marks 21B, 21B attached in advance to the chuck mechanism 42 of the disk supply unit 26.

Because of the recognition, the slave disk 40 is positioned by the Y to Z-axis robots 28 and 29 of the disk supply unit 26 so as to match the center of the master disk 46 calculated from the reference mark 21A with the center of the slave disk 40 calculated from the recognition marks 21B, 21B of the chuck mechanism 42.

Next, the slave disk 40 is moved to the position to be firmly attached to the master disk 46 fixed inside the fixed side holder 23 by the X-axis robot 27 of the disk supply unit 26 so as to be absorbed and fixed inside the fixed side holder 23.

Next, the electromagnetic valve 96c of the depressurization piping system route 96 shown in FIGS. 4A and 4B is driven to cut off a connection between the ventilation route 42g of the chuck mechanism 42 (inside the chuck arm 42a) and the depressurization device, and the electromagnetic valve 98c of the pressurization piping system route 98 is driven to connect the ventilation route 42g of the chuck mechanism 42 (inside the chuck arm 42a) to the pressurization device by way of the piping 98a. Thus, the air is supplied in the direction of the arrow 98e and the absorption of the slave disk 40 is released.

In this case, the air supplied from the pressurization device passes the air filter 98b provided in the piping 98a, and so it can prevent the slave disk and its periphery from getting contaminated by discharging fine particles and dirt from the chuck mechanism 42.

When releasing the absorption of the slave disk 40, there is no difficulty in releasing operation if a large flow volume of the air is supplied from the pressurization device without driving the electromagnetic valve 96c to cut off a connection between the ventilation route 42g of the chuck mechanism 42 of the depressurization piping system route 96 and the depressurization device.

Next, the moving side holder 24 is moved by a robot 70 toward the fixed side holder 23, and the slave disk 40 is sandwiched on both sides by the two master disks 46, 46. Thus, both sides of the slave disk 40 are held tightly in a state of being firmly attached to the two master disks 46, 46.

Next, the index table 50 is rotated by 90 degrees to position the holder unit 22 at a magnetic transfer process position 84 of the next process. And the coil units 32, 32 are moved to both sides of the holder unit 22 so as to add the magnetic fields from both sides while rotating the holder unit 22. Thus, a magnetic information pattern of the master disks 46, 46 is magnetically transferred to both sides of the slave disk 40.

After the magnetic transfer, the coil units 32, 32 are evacuated to their initial positions, and the index table 50 is rotated by 90 degrees to position the holder unit 22 at a disk ejection process position 86 of the next process.

Next, the moving side holder 24 is moved apart from the fixed side holder 23. In this case, the magnetically transferred slave disk 40 is absorbed inside the fixed side holder 23 as in the case of supply.

Next, the chuck mechanism 52 of the disk ejection unit 34 enters between the fixed side holder 23 and moving side holder 24 to suck and hold the internal diameter portion of the slave disk 40. The absorption of the slave disk 40 of the fixed side holder 23 is released and the chuck mechanism 52 of the disk ejection unit 34 is moved by the X-axis robot 35 of the disk ejection unit 34 so as to separate the slave disk 40 from the master disk 46 of the fixed side holder 23.

Details of suction and holding of the slave disk 40 by the disk ejection unit 34 are the same as the operation of suction and holding of the slave disk 40 by the disk supply unit 26. Therefore, overlapping descriptions will be omitted.

Next, the slave disk 40 is evacuated by the Y-axis robot 36 from the gap of the opened holder unit 22 in the Y-axis direction in the state of being absorbed and grasped by the chuck mechanism 52 of the disk ejection unit 34. The slave disk 40 is rotated by 180 degrees by the rotary cylinder 54 in the Y to Z plane and along a circular route passing outside the apparatus so as to have its vertical orientation inverted including the chuck mechanism 52.

Next, the slave disk 40 and chuck mechanism 52 are moved onto the disk ejection cassette 56 by the X to Y to Z robots 35, 36 and 37 of the disk ejection unit 34, and the slave disks 40 are sequentially housed in the disk ejection cassette 56 one by one.

Details of releasing of the slave disk 40 by the disk ejection unit 34 are the same as the releasing operation of the slave disk 40 by the disk supply unit 26. Therefore, overlapping descriptions will be omitted.

As for the series of operations, it is possible to perform the processes in parallel by positioning the holder unit 22 at each process position while intermittently rotating the index table 50 in sequence.

According to this embodiment described above, it is possible to switch between the depressurization piping system route 96 and the pressurization piping system route 98 connected to the ventilation route 42g of the chuck mechanism 42 for absorbing and holding the slave disk 40. Therefore, it is possible to use the depressurization piping system route 96 on absorbing the slave disk 40 and use the pressurization piping system route 98 on releasing the slave disk 40 so as to prevent the slave disk and its periphery from getting contaminated by discharging fine particles and dirt from the chuck mechanism 42.

Next, another embodiment of the present invention will be described. This embodiment is only different from the embodiments previously described by using FIGS. 1 to 5 as to the depressurization piping system route 96 and pressurization piping system route 98 connected to the chuck mechanism. The other configurations are the same. Therefore, only the different configurations will be described.

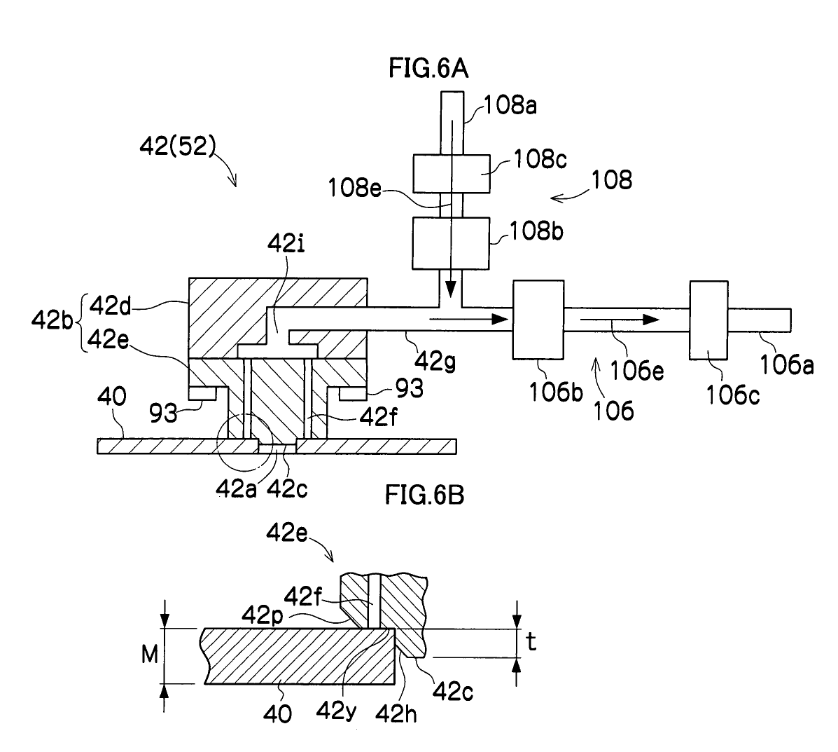

FIGS. 6A and 6B show the chuck mechanism 42 (52) for absorbing the internal diameter portion of the slave disk 40, where FIG. 6A is a side sectional view and FIG. 6B is a partially enlarged view of the inside of the circle of FIG. 6A describing the displacement prevention guide 42c. The chuck mechanism 42 has the same configuration as the chuck mechanism 42 of FIGS. 4A and 4B. Therefore, overlapping descriptions will be omitted.

The main body portion 42d is connected to a depressurization piping system route 106 for performing depressurization and canceling depressurization and a pressurization piping system route (air releasing piping system route) 108 via the ventilation route 42g as the channel inside the chuck arm 42a. Thus, the absorption chuck 42b can perform or cancel the absorption of the inner periphery portion of the slave disk 40.

To be more specific, the ventilation route 42g in the chuck arm 42a is branched into a piping 106a of the depressurization piping system route 106 and a piping 108a of the pressurization piping system route 108. The piping 106a of the depressurization piping system route 106 has an air filter 106b as the filter device and an electromagnetic valve 106c provided thereto in order from the branching point. The end of the piping 106a is connected to a depressurization device (rotary vacuum pump for instance) not shown.

The piping 108a of the pressurization piping system route 108 has an air filter 108b as the filter device and an electromagnetic valve 108c provided thereto in order from the branching point. The end of the piping 108a is open in the atmosphere.

The electromagnetic valve 106c of the depressurization piping system route 106 and the electromagnetic valve 108c of the pressurization piping system route 108 can be driven by an unshown control device (personal computer for instance) respectively. Thus, the absorption chuck 42b can perform or release the absorption of the inner periphery portion of the slave disk 40.

The action of the chuck mechanism 42 described above is almost the same as the action of the chuck mechanism 42 already described (FIGS. 4A and 4B). Therefore, a detailed description thereof will be omitted.

When releasing the absorption of the slave disk 40, the electromagnetic valve 106c of the depressurization piping system route 106 is driven to cut off the connection between the ventilation route 42g of the chuck mechanism 42 (inside the chuck arm 42a) and the depressurization device and drive the electromagnetic valve 108c of the pressurization piping system route 108 so as to render the ventilation route 42g of the chuck mechanism 42 (inside the chuck arm 42a) communicated with the atmosphere by way of the piping 108a. Thus, the air is supplied in the direction of an arrow 108e and the absorption of the slave disk 40 is released.

Next, a further embodiment of the present invention will be described. This embodiment relates to a method of disk delivery in particular. According to this embodiment, use of the chuck mechanism 42 already described (refer to FIGS. 4A and 4B) is desirable. However, the chuck mechanism of another configuration may also be used. Hereafter, this configuration will be described.

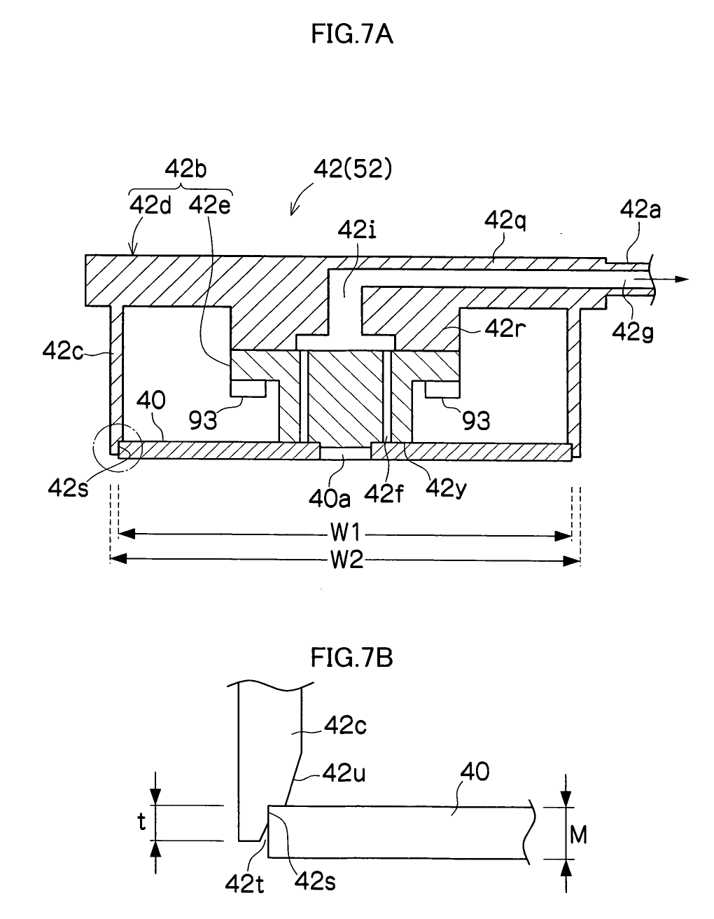

FIGS. 7A and 7B show another embodiment of the displacement prevention guide 42c in the case of fitting it into the periphery of the slave disk 40, where FIG. 7A is a side sectional view and FIG. 7B is a partially enlarged view of the inside of the circle of FIG. 7A as a schematic diagram describing the displacement prevention guide 42c.

As shown in FIGS. 7A and 7B, the absorption chuck 42b has the main body portion 42d including the decompression chamber 42i therein and the absorption board 42e coupled by screws 93. The main body portion 42d has the displacement prevention guide 42c provided thereon. In this case, the displacement prevention guide 42c may be formed either integrally with or separately from the main body portion 42d. To be more specific, the main body portion 42d is configured by a large-diameter portion 42q approximately equal to an external diameter of the slave disk 40 and a small-diameter portion 42r approximately equal to the absorption board 42e. The cylindrical displacement prevention guide 42c is supported at a peripheral position of the large-diameter portion 42q on the slave disk 40 side.

An internal diameter W1 of the displacement prevention guide 42c is formed to be smaller than the diameter of the slave disk 40 while an external diameter W2 is formed to be larger than the diameter of the slave disk 40. In addition, a step-like notch 42s is formed inside the end of the displacement prevention guide 42c. The notch 42s has the peripheral border of the slave disk 40 fitted therein. The notch 42s also has a taper 42t for widening the end of the notch 42s like a horn formed thereon.

Thus, on absorbing the slave disk 40 with the absorption chuck 42b, the slave disk 40 is smoothly led to the notch 42s of the displacement prevention guide 42c so as to put the displacement prevention guide 42c and slave disk 40 in a fitted state. Of the notch 42s, an edge of the portion in contact with the surface of the slave disk 40 is removed to form a taper 42u. This is intended to keep the displacement prevention guide 42c from contacting the servo area as with the taper 42p shown in FIGS. 4A and 4B.

The displacement prevention guide 42c fitted into the peripheral border of the slave disk 40 is not limited to a cylindrical form, but the cylindrical form may be vertically divided into multiple divided pieces to have the notch 42s and taper 42u formed at the end of each divided piece although not shown. It is possible, by thus dividing it into the divided pieces, to facilitate elastic deformation of the displacement prevention guide 42c so that it becomes even easier to fit the displacement prevention guide 42c into the slave disk 40. If there are too many divided pieces, however, the fitting force becomes weaker and may be a cause of a displacement of the absorption position. Therefore, there should be five or fewer divided pieces.

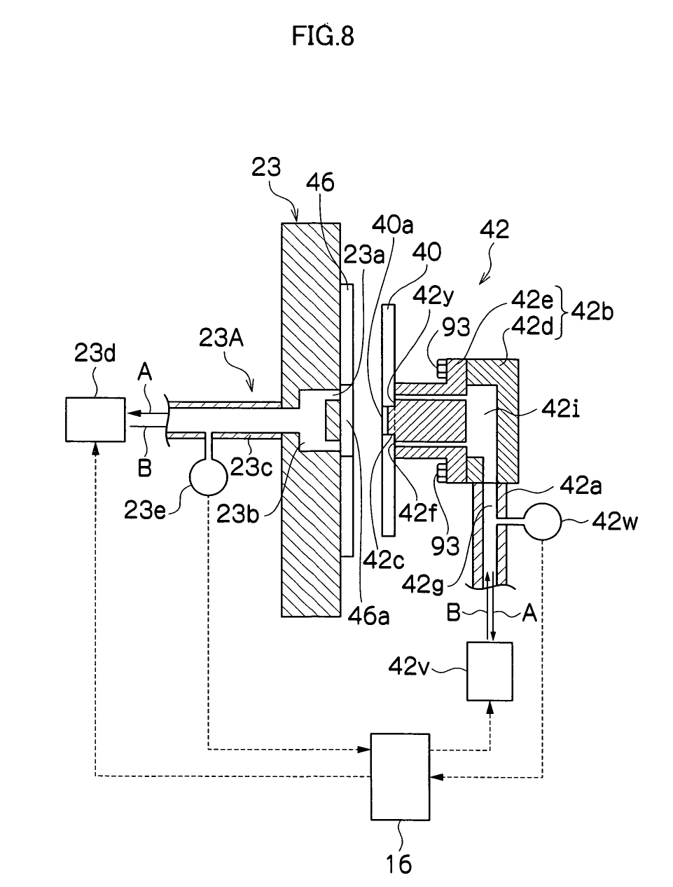

As shown in FIG. 7B, the thickness t of the fitted portion of the displacement prevention guide 42c is rendered smaller than the thickness M of the slave disk 40 as in the case of FIGS. 4A and 4B. As in the case of FIGS. 4A and 4B, the main body portion 42d is connected to an absorption and release device 42v (refer to FIG. 8) for performing and releasing the absorption via the ventilation route 42g formed inside the chuck arm 42a whereby the absorption chuck 42b can perform or release the absorption of the slave disk 40.

The slave disk 40 taken out of the disk supply cassette 38 by the disk supply unit 26 is absorbed and carried to the holder unit 22 and relatively positioned against the master disk 46 mounted in advance on the fixed side holder 23 of the holder unit 22. The slave disk 40 absorbed by the absorption chuck 42b is absorbed by a second absorption chuck 23A (refer to FIG. 8) of the fixed side holder 23 holding the master disks 46. Thus, the slave disk 40 is delivered to the fixed side holder 23, and the magnetic information recording surface of the master disk 46 and the magnetic information transferred surface of the slave disk 40 are held in a firmly attached state.

FIG. 8 is a schematic diagram for describing a mechanism which delivers the slave disk 40 absorbed by the absorption chuck 42b of the disk supply unit 26 to the second absorption chuck of the fixed side holder 23. As for the absorption chuck 42b of FIG. 8, descriptions of the portions already described above will be omitted.

An absorption opening 23a is formed like a ring at the center of the surface of the fixed side holder 23. The absorption opening 23a is connected to an absorption and release device 23d which generates absorptive power to the absorption opening 23a with a piping 23c via a decompression chamber 23b formed inside the fixed side holder 23 and releases the absorptive power. The absorption opening 23a does not need to be one continuous opening like a ring. It is also possible to form a ring shape discontinuously with multiple openings.

An arrow A of FIG. 8 is the flow of the air in absorption operation, and an arrow B is the flow of the air in release operation. Thus, the fixed side holder 23 is integrally formed with the second absorption chuck 23A. The fixed side holder 23 has the master disk 46 having a center opening 46a of a larger diameter than the ring diameter of the absorption opening 23a fixed and held on its surface (absorption surface side) by adhesion. Thus, it is possible, by having the absorption operation performed by the absorption and release device 23d in the state of firmly attaching the slave disk 40 to the master disk 46, to generate the absorptive power in the absorption opening 23a and absorb the inner periphery portion of the slave disk 40 to the fixed side holder 23 through the center opening 46a of the master disk.

The absorption and release device 23d of the second absorption chuck 23A is connected via a control cable to a control device 16 which controls on and off and absorptive power (degree of vacuum) of the absorption and release device 23d. A pressure sensor 23e is provided to a piping 23c so as to have a measured degree of vacuum inputted to the control device 16.

The absorption chuck 42b of the disk supply unit 26 is connected to the absorption and release device 42v of the absorption chuck 42b for generating and releasing the absorption power in the absorption opening 42f via the chuck arm 42a having the ventilation route 42g.

Furthermore, the absorption and release device 42v of the absorption chuck 42b is connected to the control device 16 via the control cable, and a pressure sensor 42w is provided to the chuck arm 42a so as to have the measured degree of vacuum inputted to the control device 16.

Next, a magnetic transfer method of a magnetic transfer apparatus 10 configured as above will be described. The procedure from a start of the operation until having the slave disk 40 supplied to the holder unit 22 is the same as that in the embodiments already described, and so a description thereof will be omitted.

In FIG. 8, the slave disk 40 is moved to the position to be firmly attached to the master disk 46 held inside the fixed side holder 23 by the X-axis robot 27 of the disk supply unit 26, and the slave disk 40 has the absorption of the absorption chuck 42b (first absorption chuck) absorbing the slave disk 40 released and gets absorbed and fixed inside the fixed side holder 23.

When delivering the slave disk 40 from the absorption chuck 42b to the fixed side holder 23, the control device 16 controls on and off and degree of vacuum of the absorption and release device 42v of the absorption chuck 42b and the absorption and release device 23d of the second absorption chuck 23A based on measurement values of the two pressure sensors 42w, 23e so as to have the slave disk 40 absorbed by the second absorption chuck 23A by rendering the absorptive power for absorbing the slave disk 40 with the second absorption chuck 23A higher than the absorptive power of the absorption chuck 42b (first absorption chuck) and have the absorption of the absorption chuck 42b released thereafter.

Thus, no displacement is generated on delivering the slave disk 40 from the absorption chuck 42b of the disk supply unit 26 to the second absorption chuck 23A of the fixed side holder 23.

Furthermore, on this delivery, the absorption of the absorption chuck 42b is released in the state of having the displacement prevention guide 42c fitted into the center opening 40a of the slave disk 40 or the peripheral border of the slave disk 40. It is thereby possible to prevent the displacement even more securely.

According to this embodiment, the displacement prevention guide 42c is provided to the absorption chuck 42b. It is also possible, however, to provide the displacement prevention guide to be inserted and fitted into the center opening 40a of the slave disk 40 in the central portion of the surface (absorption surface) of the second absorption chuck 23A so as to have the displacement prevention guide inserted into the center opening 40a of the slave disk 40 on delivering the slave disk 40 from the absorption chuck 42b to the second absorption chuck 23A.

Next, the moving side holder 24 is moved by the robot 70 toward the fixed side holder 23, and the slave disk 40 is sandwiched on both sides by the two master disks 46, 46. The index table 50 is rotated by 90 degrees to position the holder unit 22 at the magnetic transfer process position 84. The magnetic fields are added from both sides while having the holder unit 22 rotated by the coil units 32, 32 so as to perform the magnetic transfer.

After the magnetic transfer, the coil units 32, 32 are evacuated to their initial positions, and the index table 50 is positioned at the disk ejection process position 86. The moving side holder 24 is moved apart from the fixed side holder 23. In this case, the magnetically transferred slave disk 40 is absorbed inside the fixed side holder 23 as in the case of supply.

Next, the chuck mechanism 52 of the disk ejection unit 34 enters between the fixed side holder 23 and moving side holder 24 to absorb the slave disk 40. The absorption of the slave disk 40 of the fixed side holder 23 is released and the chuck mechanism 52 of the disk ejection unit 34 is moved by the X-axis robot 35 of the disk ejection unit 34 so as to separate the slave disk 40 from the master disk 46 of the fixed side holder 23. When the chuck mechanism 52 of the disk ejection unit 34 receives the slave disk 40 from the fixed side holder 23, the slave disk 40 is absorbed by an absorption chuck 52b while fitting a displacement prevention guide 52c into the center opening 40a of the slave disk 40 or the peripheral border of the slave disk 40. It is thereby possible to have the slave disk 40 received by the chuck mechanism 52 without generating a displacement of the absorption position.

Next, the slave disk 40 is evacuated by the Y-axis robot 36 from the gap of the opened holder unit 22 in the Y-axis direction in the state of being grasped by the chuck mechanism 52 of the disk ejection unit 34, and is moved onto the disk ejection cassette 56 by the X to Y to Z robots 35, 36 and 37 of the disk ejection unit 34 to have the slave disks 40 sequentially housed in the disk ejection cassette 56 one by one.

The above described the embodiments of the disk holding apparatus and the magnetic transfer method and apparatus using the same according to the present invention. However, the present invention is not limited to the embodiments but various embodiments can be adopted.

For instance, according to the embodiments, the magnetic transfer is performed by placing the master disks 46, 46 on both sides of the slave disk 40. However, it may also be the configuration in which the magnetic transfer is performed by placing the master disk 46 only on one side of the slave disk 40.

The configuration of the holder unit 22 is not limited to the embodiments but various embodiments can be adopted.

Furthermore, the configuration of the magnetic transfer apparatus 10 is not limited to a rotary index method of the embodiments but various embodiments such as an inline index method can be adopted.

The embodiments described the magnetic transfer. However, the disk holding apparatus according to the present invention is broadly applicable to other uses, such as delivery of the disks between the apparatuses and handling of the disks on other apparatuses.

What is claimed is:

1. A disk holding apparatus comprising:
a chuck which has one or more suction openings at its end and absorbs a disk with the suction openings,
wherein a channel in communication with the suction openings is provided in the chuck, and a depressurization piping system route and a pressurization piping system route connected to the channel are switchable.

2. The disk holding apparatus according to claim 1, wherein the pressurization piping system route is open to atmospheric pressure.

3. The disk holding apparatus according to claim 1, wherein a filter device is provided in the depressurization piping system route and/or the pressurization piping system route.

4. The disk holding apparatus according to claim 2, wherein a filter device is provided in the depressurization piping system route and/or the pressurization piping system route.

5. A magnetic transfer apparatus comprising:
a holding device which holds a master disk having a magnetic pattern with a holder portion;
a disk holding apparatus according to claim 1;
a supply device which carries a slave disk absorbed by an absorption chuck of the disk holding apparatus and supplies it to be opposed to the master disk held by the holder portion; and
a magnetic field application device which adds a magnetic field to the holder portion to transfer the magnetic pattern of the master disk to the slave disk.

6. A magnetic transfer apparatus comprising:
a holding device which holds a master disk having a magnetic pattern with a holder portion;
a disk holding apparatus according to claim 2;
a supply device which carries a slave disk absorbed by an absorption chuck of the disk holding apparatus and supplies it to be opposed to the master disk held by the holder portion; and
a magnetic field application device which adds a magnetic field to the holder portion to transfer the magnetic pattern of the master disk to the slave disk.

7. A magnetic transfer apparatus comprising:
a holding device which holds a master disk having a magnetic pattern with a holder portion;
a disk holding apparatus according to claim 3;
a supply device which carries a slave disk absorbed by an absorption chuck of the disk holding apparatus and supplies it to be opposed to the master disk held by the holder portion; and
a magnetic field application device which adds a magnetic field to the holder portion to transfer the magnetic pattern of the master disk to the slave disk.

8. A magnetic transfer apparatus comprising:
a holding device which holds a master disk having a magnetic pattern with a holder portion;
a disk holding apparatus according to claim 4;
a supply device which carries a slave disk absorbed by an absorption chuck of the disk holding apparatus and supplies it to be opposed to the master disk held by the holder portion; and
a magnetic field application device which adds a magnetic field to the holder portion to transfer the magnetic pattern of the master disk to the slave disk.

9. A magnetic transfer method comprising the steps of:
absorbing the slave disk with the absorption chuck by use of the disk holding apparatus according to claim 1;
carrying the absorbed slave disk and supplying it to be opposed to the master disk held by the holder portion;
pressure-welding the master disk to the supplied slave disk to hold the supplied slave disk tightly; and
adding a magnetic field to the holder portion to transfer the magnetic pattern on the master disk to the slave disk.

10. A magnetic transfer method comprising the steps of:
absorbing the slave disk with the absorption chuck by use of the disk holding apparatus according to claim 2;
carrying the absorbed slave disk and supplying it to be opposed to the master disk held by the holder portion;
pressure-welding the master disk to the supplied slave disk to hold the supplied slave disk tightly; and
adding a magnetic field to the holder portion to transfer the magnetic pattern on the master disk to the slave disk.

11. A magnetic transfer method comprising the steps of:
absorbing the slave disk with the absorption chuck by use of the disk holding apparatus according to claim 3;
carrying the absorbed slave disk and supplying it to be opposed to the master disk held by the holder portion;
pressure-welding the master disk to the supplied slave disk to hold the supplied slave disk tightly; and
adding a magnetic field to the holder portion to transfer the magnetic pattern on the master disk to the slave disk.

12. A magnetic transfer method comprising the steps of:
absorbing the slave disk with the absorption chuck by use of the disk holding apparatus according to claim 4;
carrying the absorbed slave disk and supplying it to be opposed to the master disk held by the holder portion;
pressure-welding the master disk to the supplied slave disk to hold the supplied slave disk tightly; and
adding a magnetic field to the holder portion to transfer the magnetic pattern on the master disk to the slave disk.

13. A method of disk delivery of a magnetic transfer apparatus which magnetically transfers a magnetic pattern of a master disk held by a holder portion to a slave disk, and absorbs and carries the slave disk with a supply device including a first absorption chuck to deliver it to a second absorption chuck of the holder portion, wherein:
the slave disk is absorbed by the second absorption chuck by rendering absorptive power for absorbing the slave disk with the second absorption chuck higher than the absorptive power of the first absorption chuck and absorption of the first absorption chuck is released thereafter.

14. The method of disk delivery of a magnetic transfer apparatus according to claim 13, wherein, on delivering the slave disk from the first absorption chuck to the second absorption chuck, the slave disk is delivered in a state of having a displacement prevention guide provided to the first or second absorption chuck fitted into a center opening or a peripheral rim of the slave disk.

15. A magnetic transfer apparatus for transferring a magnetic pattern of a master disk held by a holder portion to a slave disk and absorbing and carrying the slave disk with a supply device including a first absorption chuck to deliver it to a second absorption chuck of the holder portion, the apparatus comprising:
a control device which controls an absorption and release device of the first and second absorption chucks to have the slave disk absorbed by the second absorption chuck by rendering absorptive power for absorbing the slave disk with the second absorption chuck higher than the absorptive power of the first absorption chuck and release absorption of the first absorption chuck thereafter.

16. The magnetic transfer apparatus according to claim 15, comprising:
a displacement prevention guide which is provided to at least one of the first and second absorption chucks and prevents a displacement of an absorption position on delivery from the first absorption chuck to the second absorption chuck.

17. The magnetic transfer apparatus according to claim 15, comprising:
a displacement prevention guide which is provided to at least one of the first and second absorption chucks and prevents a displacement of an absorption position on delivery from the first absorption chuck to the second absorption chuck, and wherein:
an end of the displacement prevention guide is formed so as not to project from an opposite surface of an absorption surface of the slave disk.

18. The magnetic transfer apparatus according to claim 16, wherein the displacement prevention guide is formed to be fitted into a center opening formed on the slave disk.

19. The magnetic transfer apparatus according to claim 17, wherein the displacement prevention guide is formed to be fitted into a center opening formed on the slave disk.

20. The magnetic transfer apparatus according to claim 16, wherein the displacement prevention guide is formed to be fitted into a peripheral rim of the slave disk.

21. The magnetic transfer apparatus according to claim 17, wherein the displacement prevention guide is formed to be fitted into a peripheral rim of the slave disk.
